(19) United States
(12) Patent Application Publication
(10) Pub. No.: US 2022/0017340 A1
(43) Pub. Date: Jan. 20, 2022

(54) MOTORCYCLE LIFT

(71) Applicants: Edward Herman Smith, Langley (CA); Ryan Edward Smith, Langley (CA)

(72) Inventors: Edward Herman Smith, Langley (CA); Ryan Edward Smith, Langley (CA)

(21) Appl. No.: 16/931,354

(22) Filed: Jul. 16, 2020

(51) Int. Cl. B66F 7/06; B66F 3/12

(52) U.S. Cl. CPC B66F 7/065; B66F 3/12

(57) ABSTRACT

A motorcycle lift that is configured to independently raise and/or lower the front end and rear end of a motorcycle that has been superposed the motorcycle lift. The motorcycle lift includes a frame having a central longitudinal support member having a first end and a second end. A lateral support member is movably secured to the first end of the central longitudinal support member. A first lifting mechanism and a second lifting mechanism are secured to the central longitudinal support member at opposing ends thereof. The central longitudinal support member includes a plurality of apertures on opposing sides thereof. The lateral support member is operably coupled to the central longitudinal support member with fasteners to the plurality of apertures and movable along a length thereof. The second lifting mechanism is movable along a length of the central longitudinal support member.

### FIELD OF THE INVENTION

The present invention relates generally to motorcycle mechanical equipment, more specifically but not by way of limitation, a motorcycle lift configured to have a motorcycle superposed thereon and provide a vertical lifting of the motorcycle.

### BACKGROUND

Millions of people ride motorcycles on a daily basis either for pleasure or as a vehicle to transport to work or other required location. As with any combustible engine, motorcycles require routine maintenance such as but not limited to oil changes, brake work and many other items that are required to be either routinely inspected, changed or replaced. In addition to routine maintenance individuals that own motorcycles often customize their motorcycles by adding items such as but not limited to custom exhaust systems. As is known in the art, positioning and balancing motorcycles during maintenance or other work can be a challenge. Conventional motorcycles have a side stand for support which is suitable for parking the motorcycle but does not provide the optimum position or height for performing many tasks on the motorcycle.

In order to accomplish the aforementioned tasks many individuals will utilize a motorcycle lift. A conventional motorcycle lift is a platform that has a solid upper surface wherein the motorcycle is rolled onto the platform and secured thereto. The entire platform can be raised or lowered and the wheels are often locked into place using wheel chocks or other elements. The solid platform of the conventional motorcycle lifts can inhibit access to some parts of the motorcycle or further render some tasks more difficult. Another issue with conventional motorcycle lift platforms is the lack of lateral stability. The conventional motorcycle lift platform is generally rectangular in shape and lacks sufficient lateral support. Lastly, conventional motorcycle lifts do not have the ability to independently raise or lower either the front end or rear end of the motorcycle.

Accordingly, there is a need for a motorcycle lift operable to raise and lower a motorcycle superposed thereon wherein the motorcycle lift of the present invention includes a frame providing lateral stability and further includes independent first and second lifting members.

### SUMMARY OF THE INVENTION

It is the object of the present invention to provide a motorcycle lift configured to have a motorcycle superposed thereon wherein the present invention includes a frame.

Another object of the present invention is to provide a lifting apparatus operable to lift a motorcycle for a user to access a desired section or perform a maintenance activity wherein the frame of the present invention includes a central longitudinal support member having a first end and a second end.

A further object of the present invention is to provide a motorcycle lift configured to have a motorcycle superposed thereon wherein the frame further includes a first lifting member proximate the second end of the central longitudinal support member.

Still another object of the present invention is to provide a lifting apparatus operable to lift a motorcycle for a user to access a desired section or perform a maintenance activity that further includes a second lifting member secured proximate the first end of the central longitudinal support member.

An additional object of the present invention is to provide a motorcycle lift configured to have a motorcycle superposed thereon wherein the frame further includes a lateral support member that is proximate the first end of the central longitudinal support member.

Yet a further object of the present invention is to provide a lifting apparatus operable to lift a motorcycle for a user to access a desired section or perform a maintenance activity wherein the lateral support member is perpendicular to the central longitudinal support member.

Another object of the present invention is to provide a motorcycle lift configured to have a motorcycle superposed thereon wherein the second lifting member is movably coupled to the lateral support member.

Still a further object of the present invention is to provide a lifting apparatus operable to lift a motorcycle for a user to access a desired section or perform a maintenance activity wherein the first lifting member is adjustable in position along the central longitudinal support member.

Yet another object of the present invention is to provide a motorcycle lift configured to have a motorcycle superposed thereon wherein the lateral support member is adjustable in position on the central longitudinal support member.

An additional object of the present invention is to provide a lifting apparatus operable to lift a motorcycle for a user to access a desired section or perform a maintenance activity wherein the first lifting member and second lifting member are independently movable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention; and

FIG. 2 is a side view of the present invention; and

FIG. 3 is a top perspective view of the present invention.

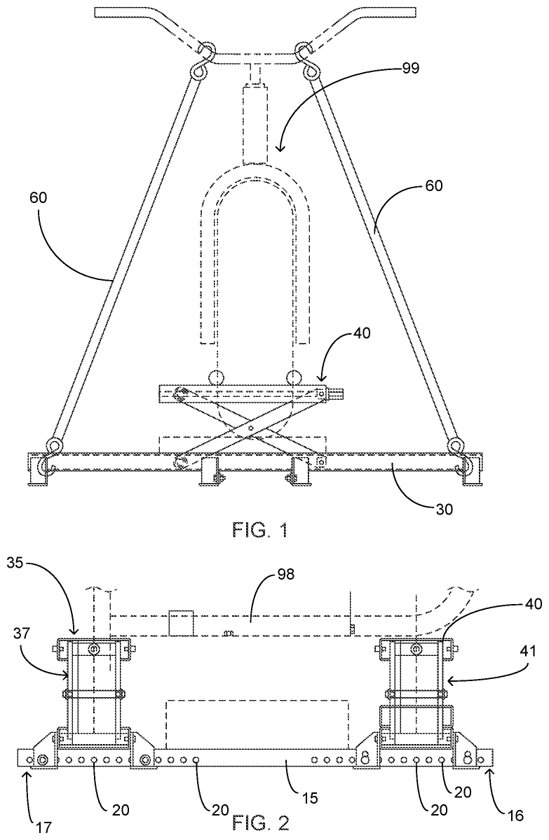

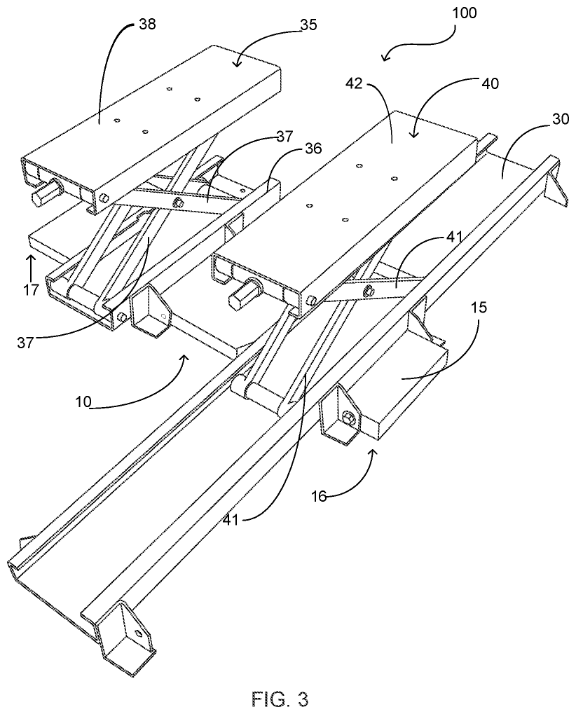

### DETAILED DESCRIPTION

Referring now to the drawings submitted herewith, wherein various elements depicted therein are not necessarily drawn to scale and wherein through the views and figures like elements are referenced with identical reference numerals, there is illustrated a motorcycle lift 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures herein, the motorcycle lift 100 includes a frame 10. The frame 10 is manufactured from a suitable durable material such as but not limited to metal. The frame 10 is constructed utilizing suitable techniques such as but not limited to welding and mechanical fasteners wherein the frame 10 is operable to provide support for a motorcycle. The frame 10 includes a central longitudinal support member 15 wherein the central longitudinal support member 15 includes a first end 16 and a second end 17. The central longitudinal support member 15 is manufactured from a durable rigid material such as but not limited to metal and is configured to provide structural support for the frame 10. It should be understood within the scope of the present invention that the central longitudinal support member 15 could be manufactured in various lengths in order to provide a frame 10 that can accommodate alternate styles of motorcycles.

The central longitudinal support member 15 includes apertures 20 formed in the central longitudinal support member 15. The apertures 20 are formed utilizing suitable techniques and provide a technique to facilitate the releasable securing and movement of the lateral support member 30 and the second lifting mechanism 35 along the central longitudinal support member 15. While not particularly illustrated herein, it should be understood within the scope of the present invention that the apertures 20 are formed on both sides of the central longitudinal support member 15. It is contemplated within the scope of the present invention that the apertures 20 could be configured to operably engage fasteners such as but not limited to bolts and nuts wherein the bores of the apertures 20 facilitate the securing of the lateral support member 30 and second lifting mechanism 35. The ability to move the lateral support member 30 and second lifting mechanism 35 longitudinally along the central longitudinal support member 15 enables accommodation of alternate styles of motorcycles and place the second lifting mechanism 35 and first lifting mechanism 40 in the desired location on the motorcycle frame 98. The lateral support member 30 is perpendicular to the central longitudinal support member 15 and includes portions thereof extending outward from opposing sides of the central longitudinal support member 15. The aforementioned provides the desired stability of the frame 10 ensuing a motorcycle 99 being superposed thereon.

The motorcycle lift 100 includes a first lifting mechanism 40 and a second lifting mechanism 35. Both the first lifting mechanism 40 and the second lifting mechanism 35 are similarly constructed and are operable to move in an upwards-downwards direction. It should be understood within the scope of the present invention that the first lifting mechanism 40 and second lifting mechanism 35 are independently movable. The first lifting mechanism 40 is operably coupled to the lateral support member 30. In a preferred embodiment, the lateral support member 30 is formed from channel beam and is C-shaped. This shape of the lateral support member 30 allows the leg members 41 to be captively secured therewithin and move in the required direction to facilitate the upwards-downwards movement of the first lifting mechanism 40. It should be understood within the scope of the present invention that the preferred embodiment of the first lifting mechanism 40 is similar to that of a conventional scissor jack wherein the leg members 41 function similar thereto. Secured to the top of the leg members 41 is the support platform 42. The support platform 42 is manufactured from metal or other suitable material and is configured to operably support a portion of the motorcycle frame 98. It should be understood within the scope of the present invention that the support platform 42 could be manufactured in alternate sizes and shapes.

The second lifting mechanism 35 is releasably secured to the central longitudinal support member 15 proximate the second end 17 thereof. The second lifting mechanism 35 is constructed similarly to the first lifting mechanism 40. The second lifting mechanism 35 includes a base support member 36 that is manufactured from a C-shaped metal channel so as to captively receive the ends of the leg members 37. The leg members 37 are movably coupled and are slidably engaged with the base support member 36 and function similarly to a conventional scissor jack so as to provide the upwards-downwards movement of the second lifting mechanism 35. The second lifting mechanism is secured to the top ends of the leg members 37. While the upper support platform 38 is illustrated herein as being rectangular in shape, it should be understood within the scope of the present invention that the upper support platform 38 could be formed in alternate shapes and sizes. As previously mentioned herein, the second lifting mechanism 35 is independently movable from the first lifting mechanism 40. This allows either a user of the motorcycle lift 100 to move either just the rear end or front end of the motorcycle frame 98 in a desired upwards or downwards direction.

As illustrated herein in FIG. 1, the motorcycle lift 100 further includes adjustable strap members 60. The adjustable strap members 60 are utilized to secure the exemplary motorcycle 99 to the motorcycle lift 100 providing lateral stability of the motorcycle 99 while superposed the motorcycle lift 100. The strap members 60 are located on opposing sides of the motorcycle 99 and it is contemplated within the scope of the present invention that the strap members 60 could be nylon or other suitable material.

While the first lifting mechanism 40 and second lifting mechanism 35 have been illustrated herein utilizing a scissor-jack like configuration, it is contemplated within the scope of the present invention that the first lifting mechanism 40 and second lifting mechanism 35 could employ alternate structures and/or techniques to achieve the desired independent upwards-downwards movement. By way of example but not limitation, the first lifting mechanism 40 and the second lifting mechanism 35 could employ hydraulic components to accomplish the desired movement.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A motorcycle lift configured to have a motorcycle superposed thereon wherein the motorcycle lift comprises:
a frame, said frame including a central longitudinal support member, said central longitudinal support member having a first end and a second end, said central longitudinal support member defining a length of the frame;
a lateral support member, said lateral support member being releasably secured to said first end of said central longitudinal support member, said lateral support member being perpendicular to said central longitudinal support member having portions extending outward from opposing sides of the central longitudinal support member,
a first lifting mechanism, wherein said first lifting mechanism is operably coupled to said lateral support member, said first lifting mechanism being movable in an upwards-downwards direction;
a second lifting mechanism, said second lifting mechanism being releasably secured to said central longitudinal support member proximate said second end thereof, said second lifting mechanism operable to move in an upwards-downwards direction; and
wherein the first lifting mechanism and the second lifting mechanism are independently movable.

2. The motorcycle lift as recited in claim 1, wherein said central longitudinal support member further includes a plurality of apertures formed therein, said plurality of apertures being proximate said first end and said second end of said central longitudinal support member.

3. The motorcycle lift as recited in claim 2, wherein said lateral support member is releasably coupled to said plurality of apertures proximate said first end of said central longitudinal support member.

4. The motorcycle lift as recited in claim 3, wherein said second lifting mechanism includes a base support member, said base support member being releasably secured to said plurality of apertures formed in said central longitudinal support member proximate said second end thereof.

5. The motorcycle lift as recited in claim 4, wherein said first lifting mechanism further includes an upper support platform, said upper support platform having an upper surface configured to receive a portion of a motorcycle frame thereon.

6. The motorcycle lift as recited in claim 5, wherein said second lifting mechanism further includes an upper support platform, said upper support platform of said second lifting mechanism has an upper surface configured to receive a portion of a motorcycle frame thereon.

7. The motorcycle lift as recited in claim 6, wherein said lateral support member is formed in a C-shape channel.

8. The motorcycle lift as recited in claim 7, and further including a pair of adjustable strap members, said pair of strap members configured to operably couple to said frame and a motorcycle superposed thereon.

9. A motorcycle lift configured to independently move a rear end or a front end of a motorcycle superposed on the motorcycle lift wherein the motorcycle lift comprises:
a frame, said frame including a central longitudinal support member, said central longitudinal support member being rectangular in shape, said central longitudinal support member having a first end and a second end, said central longitudinal support member further including a plurality of apertures formed therein, said plurality of apertures being proximate said first end and said second end of said central longitudinal support member on opposing sides thereof;
a lateral support member, said lateral support member being releasably secured to said first end of said central longitudinal support member, said lateral support member being perpendicular to said central longitudinal support member having portions extending outward from opposing sides of the central longitudinal support member,
a first lifting mechanism, wherein said first lifting mechanism is operably coupled to said lateral support member, said first lifting mechanism being movable in an upwards-downwards direction, said first lifting mechanism having an upper support platform, said upper support platform being distal to said lateral support member;
a second lifting mechanism, said second lifting mechanism having a base support member, said base support member being releasably secured to said central longitudinal support member, said base support member of said second lifting mechanism being releasably secured to said central longitudinal support member proximate said second end thereof, said second lifting mechanism operable to move in an upwards-downwards direction; and
wherein the first lifting mechanism and the second lifting mechanism are independently movable along the central longitudinal support member.

10. The motorcycle lift as recited in claim 9, wherein the first lifting mechanism and the second lifting mechanism are independently movable in an upwards-downwards direction.

11. The motorcycle lift as recited in claim 10, herein said second lifting mechanism further includes an upper support platform, said upper support platform of said second lifting mechanism has an upper surface configured to receive a portion of a motorcycle frame thereon.

12. The motorcycle lift as recited in claim 11, wherein said lateral support member is formed in a C-shape channel.
